(19) United States
(12) Patent Application Publication
(10) Pub. No.: US 2023/0229963 A1
(43) Pub. Date: Jul. 20, 2023

(54) MACHINE LEARNING MODEL TRAINING

(71) Applicant: Hewlett-Packard Development Company, L.P., Spring, TX (US)

(72) Inventors: Amelendu Iyer, Palo Alto, CA (US); Manu Rastogi, Palo Alto, CA (US); Madhu Sudan Athreya, Palo Alto, CA (US)

(73) Assignee: Hewlett-Packard Development Company, L.P., Spring, TX (US)

(21) Appl. No.: 18/002,460

(22) PCT Filed: Jun. 22, 2020
(86) PCT No.: PCT/US2020/038986

§ 371 Date: Dec. 19, 2022

(51) Int. Cl. G06N 20/00

(52) U.S. Cl. CPC G06N 20/00

(57) ABSTRACT

Examples of machine learning model training are described herein. In some examples, a method may include training, on an apparatus, an encoder machine learning model or a context machine learning model. In some examples, the method may include training the encoder machine learning model or the context machine learning model using negative samples in a latent space from emote devices and a ground truth.

### BACKGROUND

The use of electronic devices has expanded. Computing devices are a kind of electronic device that include electronic circuitry for performing processing. As processing capabilities have expanded, computing devices have been utilized to perform more functions. For example, a variety of computing devices are used for work, communication, and entertainment. Computing devices may be linked to a network to facilitate communication between computing devices.

### BRIEF DESCRIPTION OF THE DRAWINGS

FIG. 1 is a flow diagram illustrating an example of a method for machine learning model training;

FIG. 2 is a flow diagram illustrating an example of a method for machine learning model training;

FIG. 3 is a block diagram of an example of an apparatus and remote devices that may be used for machine learning model training;

FIG. 4 is a block diagram illustrating an example of a computer-readable medium for training a machine learning model; and

FIG. 5 is a diagram illustrating an example of a contrastive predictive coding machine learning model in accordance with some of the techniques described herein.

### DETAILED DESCRIPTION

Machine learning is a technique where a machine learning model is trained to perform a task or tasks based on a set of examples (e.g., data). In some examples, training machine learning models may be computationally demanding for processors, such as central processing units (CPUs) and graphics processing units (GPUs). Training a machine learning model may include determining weights corresponding to structures of the machine learning model. Artificial neural networks are a kind of machine learning model that are structured with nodes, layers, and/or connections. Deep learning is a kind of machine learning that utilizes multiple layers. A deep neural network is a neural network that utilizes deep learning. Machine learning may be utilized in various products, devices, services, and/or applications. Some examples of machine learning models may perform image classification, image captioning, object detection, object locating, object segmentation, audio classification, text classification, regression, sentiment analysis, recommendations, and/or predictive maintenance, etc. Some examples of artificial intelligence may be implemented with machine learning.

Some examples of machine learning may be implemented using multiple devices. For instance, portions of machine learning models may be distributed and/or trained by devices that are linked to a network or networks. In some examples, distributing portions of machine learning models may spread computational loads for training and/or executing machine learning models.

Communicating large amounts of data over a network for machine learning model training may be inefficient. For example, moving collected data to a centralized location (e.g., a data center or cloud server) to perform machine learning model training and/or inferencing may be cost-ineffective in terms of bandwidth usage and/or may present security and privacy risks.

Some aspects of machine learning (e.g., training and/or inferencing) may be performed by edge devices. An edge device is a non-central device in a network topology. Examples of edge devices may include smartphones, desktop computers, tablet devices, Internet of Things (IoT) devices, routers, gateways, etc. Processing data by edge devices may enhance privacy and latency. Some examples of distributed machine learning may provide distributed machine learning on edge devices while preserving privacy of the data. Some examples of distributed machine learning may include a network of edge devices and a central device or devices (e.g., server(s)). Some examples of distributed machine learning may be performed by a group of peer devices.

Some examples of deep learning may utilize a relatively large amount of training data. For instance, large training datasets may be available to train machine learning models for image classification. In some cases, inadequate training data may be available. For example, inadequate training data may be readily available for a machine learning model for printer anomaly detection from a continuous stream of microphone data. In some cases, different parties may have differing access to training data. For instance, some companies may have access to vast amounts of data relative to other companies.

Another issue with machine learning model training may relate to data privacy. Some approaches to training may involve exporting data generated by users and enterprises to the cloud for training, which may be unacceptable for privacy reasons. Some approaches that export large amounts of data may also increase cost and communication bandwidth congestion. Accordingly, some approaches to training may include training by edge devices, which may present challenges. For example, some edge computing resources may provide less computational power than some cloud computing resources. Accordingly, training some machine learning models at the edge with large amounts of training data may be less effective.

Some examples of the techniques described herein may provide machine learning model training that can utilize a relatively small amount of training data while preserving privacy when training over multiple devices. Some examples of the techniques described herein may avoid sharing raw data generated at edge devices. Some examples of the techniques described herein may include training machine learning models at edge devices, where a relatively large amount of data may be generated. Some examples of the techniques described herein may preserve privacy and leverage data generated at an edge device or edge devices. In some examples, the machine learning models may include self-supervised feature extractors that may be trained across multiple devices. In some examples, the trained machine learning models may be utilized for downstream tasks with fewer labeled samples.

Throughout the drawings, identical reference numbers may designate similar, but not necessarily identical, elements. Similar numbers may indicate similar elements. When an element is referred to without a reference number, this may refer to the element generally, without necessary limitation to any particular drawing figure. The drawing figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

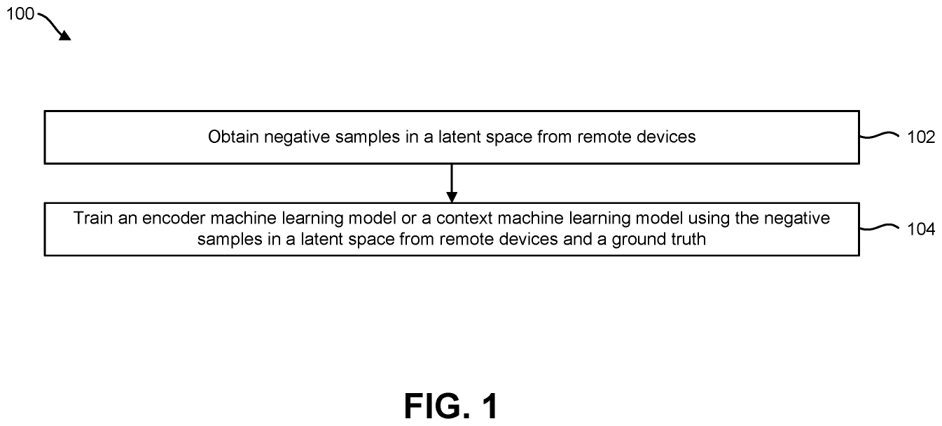

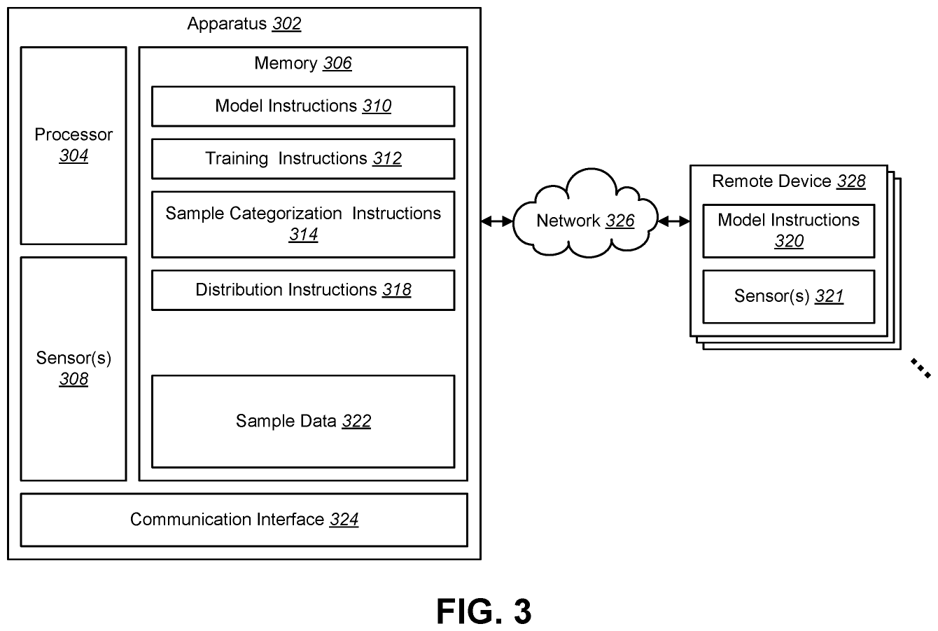

FIG. 1 is a flow diagram illustrating an example of a method 100 for machine learning model training. The method 100 and/or a method 100 element or elements may be performed by an apparatus (e.g., electronic device, computing device, server, etc.). For example, the method 100 may be performed by the apparatus 302 described in connection with FIG. 3.

The apparatus may obtain 102 negative samples in a latent space from remote devices. A remote device is a device that is separate from the apparatus. In some examples, a remote device may be linked to the apparatus via a communication network or networks. Examples of remote devices may include computing devices, electronic devices, smartphones, tablet devices, desktop computers, laptop computers, servers, smart appliances, routers, gateways, and/or combinations thereof, etc. Sensor data is data that is sensed or captured by a sensor. For example, a remote device may include a sensor or sensors that capture sensor data and/or the apparatus may include a sensor or sensors that capture sensor data. Examples of sensors may include a motion sensor, accelerometer, tilt sensor, microphone, image sensor, light sensor, pressure sensor, contact sensor, biomedical sensor (for blood measurements, for instance), other time series sensors, etc. Some examples of the techniques described herein may be used with a variety of different data types and/or modalities.

In some examples, the remote devices may include devices with sensors, such as laptop(s), webcam(s), smart camera(s), smart speaker(s), etc., with microphone(s), image sensor(s), medical devices, etc. In some examples, the remote devices may be located within a geographical area such as a single office, or may be spread across the planet in locations such as branch offices across the world. In some examples, the remote devices may be included in a device fleet. For example, the device fleet may include the remote devices and the apparatus in some approaches. In some examples, a machine learning model or models (e.g., neural networks) may be enabled across the fleet without sending raw data such as images or audio snippets between devices (e.g., from a remote device to a central apparatus in a cloud training instance, from a remote device to the apparatus in the network, between remote devices, etc.).

A latent space is a compressed space and/or a space with a lower dimensionality relative to an original dimensionality. For example, the apparatus or a remote device may compress and/or project sensor data (e.g., video, images, audio, biomedical data, biometric data, etc.) into latent space to produce a sample in latent space. For instance, sensor data may be projected into a space with a lower dimensionality than a dimensionality of the original sensor data to produce a sample in latent space. A negative sample in latent space is a sample in latent space that does not correspond to target data. A positive sample in latent space is a sample in latent space that corresponds to target data. In some examples, a remote device or remote devices may produce a sample or samples in latent space. In some examples, the apparatus may produce a sample or samples in latent space. As used herein, the term “sample” may refer to a sample in latent space.

In some examples, the remote device(s) may send sample(s) in latent space to the apparatus. The apparatus may receive the sample(s). For example, the apparatus may obtain 102 the negative samples in a latent space by receiving the negative samples through a wired and/or wireless link or links (e.g., network or networks).

The apparatus may train 104 an encoder machine learning model or a context machine learning model using the negative samples in the latent space from the remote devices and a ground truth. An encoder machine learning model is a machine learning model for encoding data. For example, an encoder machine learning model may encode sensor data to produce a sample or samples in latent space (e.g., latent-space sensor data). A context machine learning model is a machine learning model for determining a context or contexts. A context is circumstantial and/or higher-level information. For example, the context machine learning model may take a sample or samples in a latent space (e.g., encoded latent-space vectors) as input and may generate a context (e.g., context vector) that indicates slower-moving and/or higher-level information (from a signal and/or sensor data) relative to a sample or samples in the latent space. For example, in a case of audio with speech, the sample(s) (e.g., latent-space vector(s) from the encoding machine learning model) may indicate phoneme-level information, while the context(s) (e.g., context vector(s)) may indicate information about a word being uttered. A ground truth is observed data and/or data representing an actual condition. For example, a ground truth may be sensor data (e.g., image(s), audio signal(s), measurement(s), print data, radar data, etc.) representing an actual condition. The ground truth may be utilized to train a machine learning model to infer or predict a result in accordance with the ground truth. In some examples, the ground truth may be expressed in latent space. For example, the ground truth may be compressed and/or projected into latent space to produce a positive sample or samples in latent space. In some examples, training 104 may include training the encoder machine learning model and the context machine learning model. For instance, the encoder machine learning model and the context machine learning model may be jointly trained.

In some examples, training 104 the encoder machine learning model and/or the context learning model may include determining a loss using a loss function. A loss function is a function that indicates a loss (e.g., degree of error) of a prediction of a machine learning model. For example, the apparatus may utilize a machine learning model (e.g., the encoder machine learning model and/or the context learning model) to make a prediction based on an input (e.g., sensor data input). For example, a prediction or inference may be a prediction of data or a signal (e.g., image frame, audio, medical measurement, print data, radar data, etc.) for a later or future time in a time series. The apparatus may utilize the loss function to compare the prediction with a positive sample or samples in latent space and/or with a negative sample or samples in latent space. The apparatus may utilize the determined loss to adjust a weight or weights of the machine learning model (e.g., the encoder machine learning model and/or the context learning model). For example, the apparatus may adjust the weight(s) to reduce the loss. A weight is a value that scales a contribution corresponding to a component (e.g., node, connection, etc.) of a machine learning model. For instance, a weight may scale an input value to a node. In some examples, the term “weight” may refer to a gradient. A gradient may indicate an adjustment to a weight.

In some examples, the encoder machine learning model and the context learning model may be included in a contrastive predictive coding machine learning model. A contrastive predictive coding machine learning model may be trained in accordance with self-supervised learning. For instance, the contrastive predictive coding machine learning model may be trained without using labeled data. For example, the contrastive predictive coding machine learning model may predict a future observation or observations in a latent space (e.g., compressed and/or lower-dimensional space) given an observation (e.g., current observation). Prediction in latent space (e.g., a compressed space in which input data may be projected) may distinguish contrastive predictive coding machine learning models from other kinds of machine learning models.

In a case of audio (e.g., speech), for example, a contrastive predictive coding machine learning model may predict future audio (e.g., speech 100 to 200 milliseconds (ms) in the future) based on a current context. In case of video, for example, a contrastive predictive coding machine learning model may predict a future frame in latent space. For training, the loss may be a contrastive loss, where a binary classifier may be used to compare the prediction with a set of samples. For example, the set of samples may include one positive sample of the ground truth and a remainder of negative samples. In some examples, the contrastive predictive coding machine learning model may include the encoder machine learning model (e.g., neural network). In some examples, the encoder machine learning model (which may be denoted genc(x), where x denotes input data) may generate samples in a latent space (which may be denoted zₜ) from sensor data. In some examples, the contrastive predictive coding machine learning model may include the context machine learning model (e.g., neural network). In some examples, the context machine learning model may be denoted g_{c}(z≤t), where t denotes a current time, data, and/or frame. In some examples, the context machine learning model may be auto-regressive. In some examples, the context machine learning model may be used to generate a context vector (which may be denoted cₜ) from a sequence of latent-space samples (e.g., vectors) from the encoder machine learning model.

In some examples, the apparatus may distribute the trained encoder machine learning model and/or the trained context machine learning model. For example, the apparatus may send the trained encoder machine learning model and/or the trained context machine learning model and/or portions thereof (e.g., nodes, connections, layers, weights, etc.) to remote devices. For instance, the apparatus may transmit the nodes, connections, layers, and/or weights (e.g., gradients) to a remote device or remote devices using a wired link, a wireless link, and/or a network or networks.

The remote devices may receive the trained encoder machine learning model and/or the trained context machine learning model. In some examples, the remote devices may utilize the trained encoder machine learning model and/or the trained context machine learning model to perform prediction and/or inference based on local sensor data. For example, the prediction or inference may be a prediction of data or a signal (e.g., image frame, audio, medical measurement, radar data, print data, etc.) for a later or future time in a time series. In some examples, the remote devices may utilize the trained encoder machine learning model and/or the trained context machine learning model to generate samples (e.g., positive samples and/or negative samples) of latent space sensor data. In some examples, the remote devices may send the samples to the apparatus.

In some examples, the apparatus may repeat and/or iterate the method 100. For instance, the apparatus may obtain further samples (e.g., positive samples and/or negative samples) from the remote devices. The apparatus may train the encoder machine learning model and/or the context machine learning model using the samples. In some examples, the method 100 may be repeated and/or iterated until a condition is satisfied (e.g., an iteration threshold is satisfied).

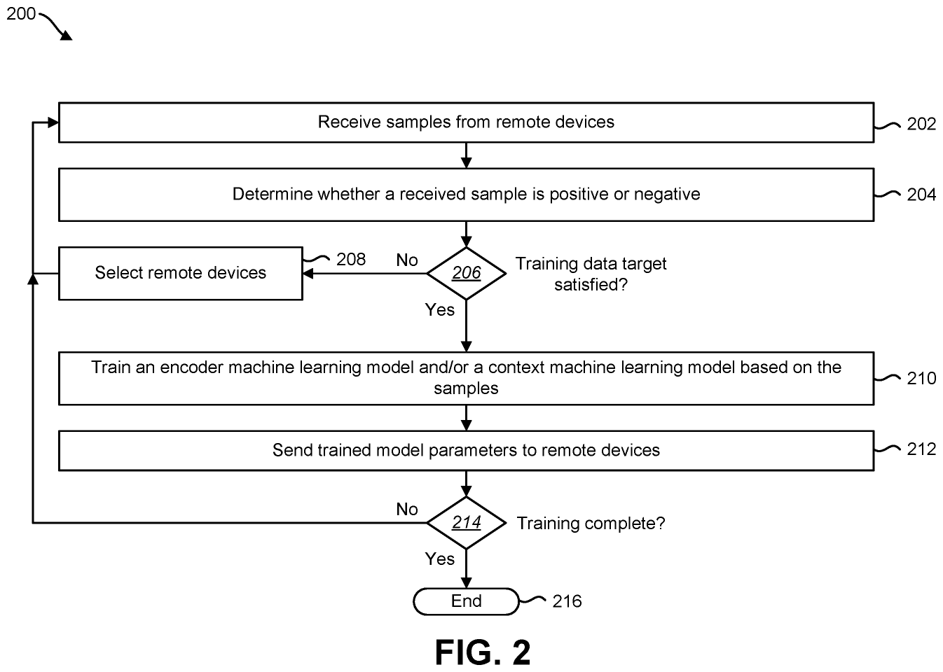

FIG. 2 is a flow diagram illustrating an example of a method 200 for machine learning model training. The method 200 and/or a method 200 element or elements may be performed by an apparatus (e.g., electronic device, computing device, server, etc.). For example, the method 200 may be performed by the apparatus 302 described in connection with FIG. 3. In some examples, the method 200 or element(s) thereof described in connection with FIG. 2 may be an example of the method 100 or element(s) thereof described in connection with FIG. 1.

The apparatus may receive 202 samples from remote devices. For example, the apparatus may receive a negative samples or samples in latent space (e.g., latent-space sensor data) and/or a positive samples or samples in latent space (e.g., latent-space sensor data) from a remote device or devices. In some examples, receiving 202 the samples may be performed as described in relation to FIG. 1. For example, the apparatus may receive 202 the samples via a wireless and/or wired connection and/or via a communication network or networks.

In some examples, the apparatus may receive metadata corresponding to the sample(s) from the remote device(s). Metadata is data about a sample or samples. Examples of metadata may include time stamps and/or positions. For instance, received metadata may include a received time stamp or time stamps. A time stamp is an indication of a time of sensor data or a sample. For example, a time stamp may indicate a time that sensor data (e.g., a frame) was captured corresponding to a sample.

In some examples, the received metadata may include a received position. A position is an indication of a location and/or pose (e.g., orientation). For example, a position may indicate a location and/or pose of a sensor corresponding to a sample (e.g., a sensor that captured sensor data used to generate the sample). In some examples, the apparatus may receive the metadata via a wireless and/or wired connection and/or via a communication network or networks.

The apparatus may determine 204 whether a received sample is positive or negative. For example, the apparatus may determine whether each received sample is positive or negative. In some examples, the apparatus may determine whether the received sample is positive or negative based on a correlation. For example, determining 204 whether the receive sample is positive or negative may include determining a correlation of the received sample with a representative positive sample. A representative positive sample may be a positive sample of in a latent space. For instance, the apparatus may determine a representative positive sample based on a ground truth (e.g., as a sample of latent-space sensor data from the apparatus). The apparatus may correlate the received sample (e.g., the received sample in a latent space, a vector) with the representative positive sample (e.g., a sample in the latent space based on a ground truth, a vector, etc.). In some examples, determining 204 whether the received sample is positive or negative may include determining whether the correlation satisfies a threshold. For example, if the correlation satisfies a threshold (e.g., is greater than or at least the threshold, 0.6, 0.65, 0.7, 0.75, 0.8, etc.), the apparatus may determine that the received sample is a positive sample. If the correlation is less than or not more than the threshold, the apparatus may determine that the received sample is a negative sample.

In some examples, the apparatus may determine whether the received sample is positive or negative based on received metadata corresponding to the received sample. For example, the received metadata may include a received time stamp, and determining 204 whether the received sample is positive or negative may include comparing the received time stamp with a time stamp of a representative positive sample. For example, the apparatus may capture a time stamp of captured sensor data used to generate the representative positive sample. In some examples, comparing the received time stamp with the time stamp of the representative positive sample may include determining a difference between the received time stamp and the time stamp of the representative positive sample. For example, if the difference (e.g., magnitude of the difference) satisfies a time stamp threshold (e.g., is less than or not more than a time stamp threshold, 5 ms, 10 ms, 50 ms, 100 ms, 500 ms, etc.), the apparatus may determine that the received sample is a positive sample. If the difference is greater than or at least the time stamp threshold, the apparatus may determine that the received sample is a negative sample.

In some examples, the received metadata may include a received position, and determining 204 whether the received sample is positive or negative may include comparing the received position with a position of a representative positive sample. For example, the apparatus may capture a position of captured sensor data used to generate the representative positive sample. In some examples, comparing the received position with the position of the representative positive sample may include determining a distance and/or pose disparity between the received position and the position of the representative positive sample. For example, if the distance satisfies a distance threshold (e.g., is less than or not more than a distance threshold, 20 centimeters (cm), 100 cm, 1 meter (m), 10 m, 50 m, etc.) and/or if the pose disparity satisfies a pose threshold (e.g., is less than or not more than a pose threshold, 5 degrees, 10 degrees, 30 degrees, etc.), the apparatus may determine that the received sample is a positive sample. If the distance is greater than or at least the distance threshold and/or if the pose disparity is greater than or at least the pose threshold, the apparatus may determine that the received sample is a negative sample.

In some examples, the apparatus may determine whether the received sample is positive or negative based on based on a correlation and/or metadata. For instance, a combination of factors may be utilized to determine whether the received sample is positive or negative. Examples of factors may include sample correlation, time stamp comparison (e.g., time stamp difference, time stamp score where a smaller time stamp difference is mapped to a larger time stamp score), and/or position comparison (e.g., distance, distance score where a smaller distance is mapped to a larger distance score, pose disparity, pose similarity score where a smaller pose disparity is mapped to a larger pose similarity score). For example, multiple factors may be combined as an average or weighted average to determine a total score. In some examples, the apparatus may compare the total score with a score threshold. For example, if the total score satisfies a score threshold (e.g., is greater than or at least the score threshold, 0.6, 0.65, 0.7, 0.75, 0.8, etc.), the apparatus may determine that the received sample is a positive sample. If the total score is less than or not more than the score threshold, the apparatus may determine that the received sample is a negative sample.

The apparatus may determine 206 whether a training data target is satisfied. A training data target is a value that indicates an amount and/or proportion (e.g., ratio, percentage, etc.) of negative samples and/or positive samples. For example, the training data target may indicate a threshold proportion of negative samples relative to positive samples and/or threshold numbers of negative samples and/or positive samples. For instance, the training data target may establish a maximum or minimum proportion of positive samples to negative samples. Examples of the training data target may include a maximum 10% of positive samples to negative samples, a maximum 70% of negative samples to positive samples, etc. In some examples, the apparatus may compare amount(s) of determined positive samples and/or negative samples to the training data target. For example, the apparatus may determine whether a proportion of negative samples satisfies the training data target. In some examples, the training data target may be set based on a received input (e.g., user input) and/or may be determined based on an amount of previous training, and/or current machine learning model performance.

In a case that the training data target is not satisfied, the apparatus may select 208 remote devices. For instance, the apparatus may select 208 a remote device or remote devices that may provide training data to satisfy the training data target. For example, if the proportion of positive samples to negative samples exceeds a maximum proportion threshold, the apparatus may select a remote device or devices that have provided a proportion of positive samples that is below the maximum proportion threshold and/or may exclude (e.g., de-select) a remote device or devices that have provided a proportion of positive samples that is above the maximum proportion threshold. In some examples, the selected 208 remote device(s) may include all, some, or none of the remote devices from which samples were previously received 202. In some examples, the apparatus may send a request to the selected remote device or devices to provide samples. The apparatus may return to receiving 202 samples from remote devices and/or determining 204 whether each received sample is positive or negative.

In a case that the training data target is satisfied, the apparatus may train 210 an encoder machine learning model and/or a context machine learning model based on the samples. In some examples, the training 210 may be performed as described in relation to FIG. 1.

The apparatus may send 212 trained model parameters to remote devices. The remote devices may include some, all, or none of the remote devices from which samples are received 202. For example, the apparatus may send weights (e.g., gradients) of the encoder machine learning model and/or of the context machine learning model. In some examples, sending 212 the trained model parameters may be performed as described in relation to FIG. 1.

The apparatus may determine 214 whether training is complete. In some examples, determining 214 whether training is complete may be performed as described in relation to FIG. 1. In some examples, the apparatus may determine whether the machine learning model training has reached a threshold (e.g., has reached a threshold number of iterations, etc.) to determine whether training is complete. For instance, the threshold number of iterations may be 50, 100, 500, 1000, 2000, etc.

In a case that it is determined 214 that training is not complete, the apparatus may return to receive 202 samples from remote devices, determine 204 whether each received sample is positive or negative, and so on. In a case that it is determined 214 that training is complete, operation may end 216. In some examples, operation(s), function(s), and/or element(s) of the method 200 may be omitted and/or combined.

FIG. 3 is a block diagram of an example of an apparatus 302 and remote devices 328 that may be used for machine learning model training. The apparatus 302 may be an electronic device, such as a central device, a server computer, a personal computer, a laptop computer, a peer device, smartphone, smart speaker, printer (e.g., two-dimensional (2D) printer, three-dimensional (3D) printer, etc.), smart appliance, IoT device, game console, virtual reality device, augmented reality device, vehicle (e.g., autonomous vehicle, semi-autonomous vehicle, etc.), aircraft, drone, robot, etc. The apparatus 302 may include and/or may be coupled to a processor 304 and/or a memory 306. The apparatus 302 may include additional components (not shown) and/or some of the components described herein may be removed and/or modified without departing from the scope of this disclosure.

The processor 304 may be any of a CPU, a digital signal processor (DSP), a semiconductor-based microprocessor, GPU, field-programmable gate array (FPGA), an application-specific integrated circuit (ASIC), and/or other hardware device suitable for retrieval and execution of instructions stored in the memory 306. The processor 304 may fetch, decode, and/or execute instructions stored in the memory 306. In some examples, the processor 304 may include an electronic circuit or circuits that include electronic components for performing a function or functions of the instructions. In some examples, the processor 304 may perform one, some, or all of the operations, aspects, etc., described in connection with one, some, or all of FIGS. 1-5. For example, the memory 306 may store instructions for one, some, or all of the operations, aspects, etc., described in connection with one, some, or all of FIGS. 1-5.

The memory 306 may be any electronic, magnetic, optical, or other physical storage device that contains or stores electronic information (e.g., instructions and/or data). The memory 306 may be, for example, Random Access Memory (RAM), Electrically Erasable Programmable Read-Only Memory (EEPROM), a storage device, an optical disc, and/or the like. In some examples, the memory 306 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some implementations, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)).

In some examples, the memory 306 of the apparatus 302 may store model instructions 310, training instructions 312, sample categorization instructions 314, and/or sample data 322. The model instructions 310 may include and/or represent a machine learning model or models, portions of a machine learning model or models, and/or components (e.g., nodes, connections, layers, weights, activation functions, etc.) of a machine learning model or models. For example, the model instructions 310 may include and/or represent an encoder machine learning model, a context machine learning model, a contrastive predictive coding machine learning model, neural network(s), etc.

In some examples, the apparatus 302 may include a communication interface 324 through which the processor 304 may communicate with an external device or devices (e.g., remote devices 328). In some examples, the apparatus 302 may be in communication with (e.g., coupled to, have a communication link with) a remote device or devices 328 via a network 326. Examples of the remote devices 328 may include computing devices, server computers, desktop computers, laptop computers, smartphones, tablet devices, game consoles, smart appliances, vehicles, autonomous vehicles, aircraft, drones, virtual reality devices, augmented reality devices, etc. Examples of the network 326 may include a local area network (LAN), wide area network (WAN), the Internet, cellular network, Long Term Evolution (LTE) network, 5G network, and/or combinations thereof, etc. In some examples, the apparatus 302 may be a central device or cloud device and the remote device(s) 328 may be edge devices. In some examples, the apparatus 302 and the remote device(s) 328 may be peer devices.

The communication interface 324 may include hardware and/or machine-readable instructions to enable the processor 304 to communicate with the remote devices 328. The communication interface 324 may enable a wired and/or wireless connection to the remote devices 328. In some examples, the communication interface 324 may include a network interface card and/or may also include hardware and/or machine-readable instructions to enable the processor 304 to communicate with the remote devices 328. In some examples, the communication interface 324 may include hardware (e.g., circuitry, ports, connectors, antennas, etc.) and/or machine-readable instructions to enable the processor 304 to communicate various input and/or output devices, such as a keyboard, a mouse, a display, another apparatus, electronic device, computing device, etc., through which a user may input instructions and/or data into the apparatus 302. In some examples, the apparatus 302 (e.g., processor 304) may utilize the communication interface 324 to send and/or receive information. For example, the apparatus 302 may utilize the communication interface 324 to distribute a machine learning model and/or machine learning model parameters (e.g., weights, gradients, etc.) to the remote device(s) 328. In some examples, the apparatus 302 may utilize the communication interface 324 to receive a sample or samples from the remote device(s) 328.

In some examples, the apparatus 302 may include a sensor or sensors 308. Examples of a sensor 308 may include a motion sensor, accelerometer, tilt sensor, microphone, image sensor, light sensor, pressure sensor, contact sensor, biomedical sensor (for blood measurements, for instance), other time series sensors, etc. The sensor(s) 308 may capture sensor data.

In some examples, each remote device 328 may include a processor, memory, communication interface, and/or sensor or sensors 321. In some examples, each of the memories of the remote devices 328 may be any electronic, magnetic, optical, or other physical storage device that contains or stores electronic information (e.g., instructions and/or data), such as, for example, RAM, EEPROM, a storage device, an optical disc, and/or the like. In some examples, each of the processors of the remote devices 328 may be any of a CPU, a DSP, a semiconductor-based microprocessor, GPU, FPGA, an ASIC, and/or other hardware device suitable for retrieval and execution of instructions stored in corresponding memory. In some examples, each communication interface of the remote devices 328 may include hardware and/or machine-readable instructions to enable the respective remote device 328 to communicate with the apparatus 302. Each of the remote devices 328 may have similar or different processing capabilities, memory capacities, and/or communication capabilities relative to each other and/or relative to the apparatus 302.

In some examples, each of the remote devices 328 may include a sensor or sensors. Examples of sensors may include a motion sensor, accelerometer, tilt sensor, microphone, image sensor, light sensor, pressure sensor, contact sensor, etc. Each of the remote devices 328 may utilize the sensor or sensors to capture sensor data (e.g., local sensor data, raw sensor data that is local to the remote device 328, etc.).

In some examples, the remote device(s) 328 may include model instructions 320. The model instructions 320 may include and/or represent a machine learning model or models, portions of a machine learning model or models, and/or components (e.g., nodes, connections, layers, weights, activation functions, etc.) of a machine learning model or models. For example, the model instructions 320 may include and/or represent an encoder machine learning model, a context machine learning model, a contrastive predictive coding machine learning model, neural network(s), etc. In some examples, the model instructions 320 may be similar to the model instructions 310 stored on the apparatus 302. In some examples, the remote device(s) 328 may execute the model instructions 320 to produce samples in a latent space from sensor data. For example, a remote device 328 may include a processor that executes the model instructions 320 to produce a sample or samples in latent space based on locally captured sensor data (e.g., remote sensor data relative to the apparatus 302). For instance, the model instructions 320 may include an encoder machine learning model (e.g., encoder neural network) that may be executed to produce the sample(s) in latent space based on the locally captured sensor data. The remote device(s) 328 may send the sample(s) of latent space sensor data to the apparatus 302 via the network 326. In some examples, the apparatus 302 may receive the samples from the remote device(s) 328 using the communication interface 324. In some examples, the apparatus 302 may store the received samples in sample data 322 in the memory 306.

The processor 304 may execute the model instructions 310 to generate a sample or samples of latent space sample data. For example, the processor 304 may generate, using an encoder machine learning model, a representative positive sample in a latent space. In some examples, generating the representative positive sample may be performed as described in relation to FIG. 1 and/or FIG. 2. In some examples, the representative positive sample may be stored in sample data 322 in the memory 306.

In some examples, the processor 304 may execute the sample categorization instructions 314 to categorize the received samples. In some examples, categorizing the received samples may be performed as described in relation to FIG. 1 and/or FIG. 2. For example, the processor 304 may determine that a received sample is a positive sample based on a correlation of the representative positive sample and a received sample. For instance, if the correlation satisfies a threshold, the received sample may be categorized as a positive sample. If the correlation does not satisfy the threshold, the received sample may be categorized as a negative sample. For example, the remote devices 328 may determine samples based on remote sensor data. In some cases, some or all of the samples received from the remote devices 328 may be categorized as negative samples.

The processor 304 may execute the training instructions 312 to determine a contrastive loss based on the representative positive sample and negative samples in the latent space. For instance, the negative samples may be determined by the remote devices 328 based on remote sensor data. In some examples, determining the contrastive loss based on the representative positive sample and the negative samples in the latent space may be performed as described in relation to FIG. 1 and/or FIG. 2.

The processor 304 may execute the training instructions 312 to train the encoder machine learning model based on the contrastive loss. In some examples, the processor 304 may train the encoder machine learning model as described in relation to FIG. 1 and/or FIG. 2. For example, the processor 304 may adjust weights and/or gradients of the machine learning model(s) based on the contrastive loss. In some examples, the processor 304 may train a context machine learning model based on the contrastive loss. For instance, the processor 304 may train the context machine learning model as described in relation to FIG. 1 and/or FIG. 2.

In some examples, the memory 306 may include distribution instructions 318. The processor 304 may execute the distribution instructions 318 to send model parameters (e.g., weights and/or gradients) to the remote device(s) 328. In some examples, the remote device(s) 328 may receive the model parameters and update the model instructions 320 in accordance with the received model parameters.

In some examples, a remote device 328 may request a sample or samples in latent space from the apparatus 302. The apparatus may provide a sample or samples in latent-space (from sensor data, for example) to the remote device 328. In some examples, the remote device 328 may perform training based on the sample(s) of latent space sensor data and/or may send model parameters to the apparatus 302. In some examples, the apparatus 302 may utilize the received model parameters to update the model instructions 310.

In some examples, the apparatus 302 may execute the machine learning model instructions 310 to produce a prediction and/or inference (e.g., future data). For example, the apparatus 302 may utilize input sensor data from the sensor(s) 308 to the machine learning model(s) to produce the prediction and/or inference. In some examples, a remote device 328 may execute the model instructions 320 to produce a prediction and/or inference based on sensor data captured by the remote device 328.

In some examples, the apparatus 302 may present the prediction and/or inference. For example, the apparatus 302 may present an indication of a result (e.g., a predicted image frame, predicted audio, etc.) on a display and/or using speakers. In some examples, the apparatus 302 may send the results to another device (e.g., server, smartphone, tablet, computer, printer, game console, etc.).

In some examples, the model instructions 310 may include a contrastive predictive coding machine learning model. For example, the model instructions 310 may include an encoder machine learning model and a context machine learning model (e.g., auto-regressive model). The contrastive predictive coding machine learning model may be trained on the apparatus 302, which may be linked to the remote devices 328. Each of the remote devices 328 may generate sensor data (e.g., images, audio, etc.). Examples of the remote devices 328 may include Internet Protocol (IP) cameras, smart speakers, robots, 3D printers etc. In some examples, the remote devices 328 may be included in a fleet of devices.

In some approaches, some of the remote devices 328 may have similar sensor observations relative to the sensor(s) 308 on the apparatus 302. For example, a remote device 328 may include an image sensor with a similar field of view to an image sensor of the apparatus 302. In some approaches, a remote device or devices 328 may be selected or excluded (e.g., deselected) for providing a sample or samples. The selection may occur before training or during training. For instance, a remote device 328 that has similar sensor observations to those of the apparatus 302 may be excluded. In this case, the selected remote devices 328 may provide negative samples (without positive samples, for instance).

In some examples, the selection may be performed based on user input, heuristics, and/or received metadata (e.g., global positioning system (GPS) location, pose, time stamp, subnet information or address, etc.). For example, remote devices 328 that have a sensor with a similar position (e.g., location and/or pose) to that of the sensor(s) 308 may be excluded. For instance, two IP cameras placed next to each other and pointing in a similar direction may produce similar sensor data. The similar sensor data may yield similar samples, which may be categorized as positive samples. A remote device 328 may be excluded in order to reduce or eliminate positive samples in some examples. In some examples, the apparatus 302 may select or exclude a remote device 328 by determining whether the remote device 328 satisfies a similarity criterion (e.g., positional difference less than or not more than a threshold, subnet address of the remote device 328 is within a same subnet as the apparatus 302, time stamp difference is less than or not more than a time stamp threshold, etc.) or a diversity criterion (e.g., positional difference greater than or at least a threshold, subnet address of the remote device 328 is in a different subnet as the apparatus 302, time stamp difference is greater than or at least a time stamp threshold, etc.). Remote device 328 selection may be performed to set and/or adjust a proportion of positive samples to negative samples or an amount of positive samples or negative samples.

In some examples, the apparatus 302 and each of the remote devices 328 may include a machine learning model with a same or similar structure (e.g., neural network replica). During training, each machine learning model may produce a prediction (e.g., prediction of a future frame, future audio signal, etc.) in latent space based on local sensor data. In some examples, the apparatus 302 and each of the remote devices 328 may send a request for negative samples (e.g., encoded Nneg samples) that may be used for calculating a contrastive loss for updating the weights of the machine learning model. In some approaches, Nneg may be a hyper-parameter. Nneg may be set based on user input or may be determined by the apparatus 302.

In some approaches, the apparatus 302 and/or the remote devices 328 may send a broadcast request for negative samples via the network 326. In some examples, the apparatus 302 may receive responses from the remote devices 328 in the fleet and may select Nneg responses, excluding responses from remote devices 328 that are deemed similar (e.g., that meet a similarity criterion). In some examples, a shared buffer may be populated with samples (e.g., encoded vectors) by the apparatus 302 and/or the remote device(s) 328 in the fleet. For instance, the shared buffer may be on a remote device 328, on the apparatus 302, and/or on another device linked to the network 326. The size of the shared buffer and the frequency with which samples are populated may be set based on user input (before training is performed, for instance). When the shared buffer receives a request for negative samples from the apparatus 302 or a remote device 328, the shared buffer may return samples that are from other devices (excluding devices with sensor data that is deemed similar, for example).

Upon receiving negative samples, the apparatus 302 and/or remote device(s) 328 may calculate gradients using a gradient descent approach. The gradients may be exchanged with other devices (e.g., machine learning models on the apparatus 302 and/or remote device(s)). In some examples, asynchronous stochastic gradient descent may be employed, which may reduce update times. The updated machine learning model (e.g., parameters, weights, etc.) may be sent to other devices linked to the network 326 (e.g., devices in the fleet).

In accordance with some of the techniques described herein, an apparatus 302 and/or remote devices 328 may not have access to raw sensor data from other devices. Samples in a latent space (e.g., encoded observations) may be used for contrastive loss during training. Accordingly, some examples of the techniques described herein may provide inherent privacy of raw sensor data during training.

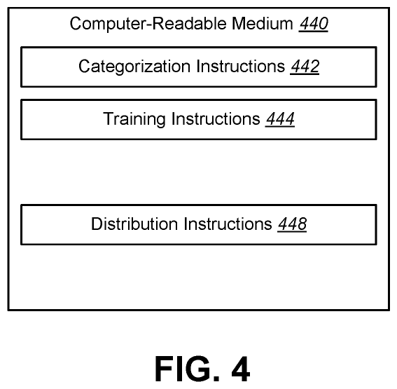

FIG. 4 is a block diagram illustrating an example of a computer-readable medium 440 for training a machine learning model. The computer-readable medium is a non-transitory, tangible computer-readable medium 440. The computer-readable medium 440 may be, for example, RAM, EEPROM, a storage device, an optical disc, and the like. In some examples, the computer-readable medium 440 may be volatile and/or non-volatile memory, such as DRAM, EEPROM, MRAM, PCRAM, memristor, flash memory, and the like. In some implementations, the memory 306 described in connection with FIG. 3 may be an example of the computer-readable medium 440 described in connection with FIG. 4.

The computer-readable medium 440 may include code (e.g., data and/or instructions or executable code). For example, the computer-readable medium 440 may include categorization instructions 442, training instructions 444, and/or distribution instructions 448.

The categorization instructions 442 may include code to cause a processor to categorize each sample of a set of received samples as a positive sample in a latent space or a negative sample in the latent space. In some examples, categorizing each sample may be accomplished as described in connection with FIG. 1, FIG. 2, and/or FIG. 3. For instance, the code to cause the processor to categorize each sample may include code to cause the processor to correlate each sample with a representative positive sample. In some examples, the code to cause the processor the categorize each sample may include code to cause the processor to compare a sample time stamp with a representative positive sample time stamp.

The training instructions 444 may include code to cause a processor to train a machine learning model based on the categorized samples. This may be accomplished as described in connection with FIG. 1, FIG. 2, and/or FIG. 3. For example, a loss may be calculated based on the positive and/or negative samples, and weights of the machine learning model (e.g., encoder machine learning model, context machine learning model, and/or contrastive predictive coding machine learning model, etc.) may be adjusted based on the loss.

The distribution instructions 448 may include code to send trained model parameters (e.g., weights, gradients, etc.) to remote devices. This may be accomplished as described in connection with FIG. 1, FIG. 2, and/or FIG. 3.

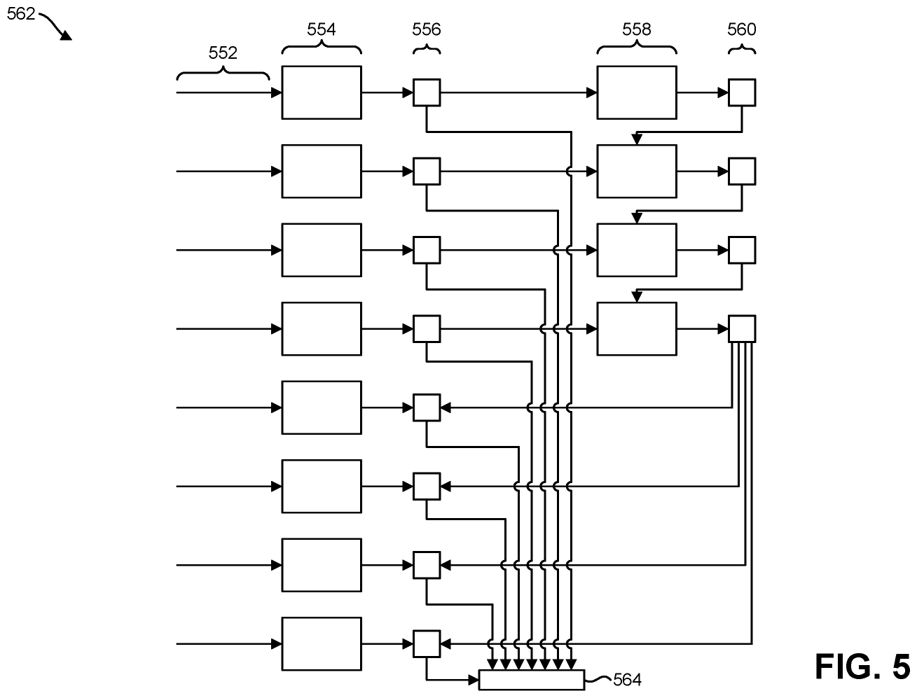

FIG. 5 is a diagram illustrating an example of a contrastive predictive coding machine learning model 562 in accordance with some of the techniques described herein. FIG. 5 illustrates an input 552 corresponding to different times. For example, the input 552 may be sensor data at different times or time periods. For instance, the input 552 may be denoted xₜ₋₃, xₜ₋₂, xₜ₋₁, xₜ, xₜ₊₁, xₜ₊₂, xₜ₊₃, xₜ₊₄, where x denotes the input (e.g., sensor data) corresponding to a time or time period t.

For a sequence of times, the input 552 may be provided to an encoder machine learning model 554. The encoder machine learning model 554 may be denoted genc(x). The encoder machine learning model 554 may produce latent-space samples 556 by compressing and/or projecting the input 552 into a lower-dimensional space. The latent-space samples 556 may be denoted zₜ₋₃, zₜ₋₂, zₜ₋₁, zₜ, zₜ₊₁, zₜ₊₂, zₜ₊₃, zₜ₊₄. The samples in latent space described herein may be examples of the latent-space samples 556.

The latent-space samples 556 up to a time t may be provided to a context machine learning model 558. The context machine learning model 558 may be denoted g_{c}. For each time, the context machine learning model 558 may produce a context vector 560, which may be denoted cₜ. The context vector prediction may utilize a prediction or predictions from past times.

Predicted latent-space samples 556 (zₜ₊₁, zₜ₊₂, zₜ₊₃, zₜ₊₄) may be based on the current context vector (cₜ). In some examples, the contrastive predictive coding machine learning model 562 may provide the latent-space samples 556 to a communication interface 564. For example, a remote device may send latent-space samples 556 to an apparatus for machine learning model training as described herein.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, aspects, and/or elements of the examples described herein may be omitted or combined.

1. A method, comprising:
training, on an apparatus, an encoder machine learning model or a context machine learning model using negative samples in a latent space from remote devices and a ground truth.

2. The method of claim 1, wherein the training comprises training the encoder machine learning model and the context machine learning model.

3. The method of claim 1, further comprising determining whether a received sample is positive or negative.

4. The method of claim 3, wherein determining whether the received sample is positive or negative comprises:
determining a correlation of the received sample with a representative positive sample; and
determining whether the correlation satisfies a threshold.

5. The method of claim 3, wherein determining whether the received sample is positive or negative is based on received metadata corresponding to the received sample.

6. The method of claim 5, wherein the received metadata comprises a received time stamp, and wherein determining whether the received sample is positive or negative comprises comparing the received time stamp with a time stamp of a positive sample.

7. The method of claim 5, wherein the received metadata comprises a received position, and wherein determining whether the received sample is positive or negative comprises comparing the received position with a position of a representative positive sample.

8. The method of claim 1, further comprising determining whether a proportion of the negative samples satisfies a training data target.

9. The method of claim 8, further comprising selecting second remote devices in response to determining that the proportion of the negative samples does not satisfy the training data target.

10. An apparatus, comprising:
a memory; and
a processor coupled to the memory, wherein the processor is to:
generate, using an encoder machine learning model, a representative positive sample in a latent space;
determining a contrastive loss based on the representative positive sample and negative samples in the latent space, wherein the negative samples are determined by remote devices based on remote sensor data; and
training the encoder machine learning model based on the contrastive loss.

11. The apparatus of claim 10, wherein the processor is to train a context machine learning model based on the contrastive loss.

12. The apparatus of claim 10, wherein the processor is to determine that a received sample is a positive sample based on a correlation of the representative positive sample and the received sample.

13. A non-transitory tangible computer-readable medium storing executable code, comprising:
code to cause a processor to categorize each sample of a set of received samples as a positive sample in a latent space or a negative sample in the latent space; and
code to cause the processor to train a machine learning model based on the categorized samples; and
code to cause the processor to send trained model parameters to remote devices.

14. The computer-readable medium of claim 13, wherein the code to cause the processor to categorize each sample comprises code to cause the processor to correlate each sample with a representative positive sample.

15. The computer-readable medium of claim 14, wherein the code to cause the processor the categorize each sample comprises code to cause the processor to compare a sample time stamp with a representative positive sample time stamp.
